(19) United States
(12) Patent Application Publication
(10) Pub. No.: US 2024/0354901 A1
(43) Pub. Date: Oct. 24, 2024

(54) REPRODUCTION APPARATUS, GENERATION APPARATUS, CONTROL METHOD, AND RECORDING MEDIUM

(71) Applicant: CANON KABUSHIKI KAISHA, Tokyo (JP)

(72) Inventor: EISHI TAKEDA, Tokyo (JP)

(21) Appl. No.: 18/633,675

(22) Filed: Apr. 12, 2024

(30) Foreign Application Priority Data
Apr. 21, 2023 (JP) 2023-070436

(51) Int. Cl. G06T 5/50; H04N 23/81

(52) U.S. Cl. CPC G06T 5/50; H04N 23/81; G06T 2207/20208; G06T 2207/20212

(57) ABSTRACT

A reproduction apparatus reproduces free viewpoint image data which includes a plurality of images obtained by shooting a subject from different viewpoints, and from which a viewpoint image corresponding to a set viewpoint can be generated. The apparatus determines whether to perform brightness adjustment on the plurality of images according to the set viewpoint; and performs the brightness adjustment on the plurality of images when the viewpoint image is generated. The brightness adjustment is determined to be performed, a different brightness adjustment is performed for (i) a first region corresponding to the subject in each of the plurality of images and (ii) a second region corresponding to parts aside from the subject.

### CROSS-REFERENCE TO PRIORITY APPLICATION

This application claims the benefit of Japanese Patent Application No. 2023-070436, filed Apr. 21, 2023, which is hereby incorporated by reference herein in its entirety.

### BACKGROUND OF THE INVENTION

### Field of the Invention

The present invention relates to a reproduction apparatus, a generation apparatus, a control method, and a recording medium, and particularly relates to a technique for generating an image corresponding to a specific viewpoint using an image group in which a subject has been shot from a plurality of viewpoints.

### Description of the Related Art

A technique is known for generating images corresponding to different viewpoints by using images shot from a plurality of viewpoints (Japanese Patent Laid-Open No. H09-284809).

Incidentally, when a subject is shot from a plurality of viewpoints, the lighting state of the subject may differ depending on the position of the viewpoint. Therefore, the region of the subject becomes a dark area depending on the position of the viewpoint at which the image is to be generated, as with a backlit position, for example. It is therefore necessary to adjust the brightness to display the subject in a suitable manner. On the other hand, because the brightness of a background region changes in response to corrections for adjusting the brightness, the background region may flicker and make it impossible to provide a suitable viewing experience in situations where the subject is viewed while changing the viewpoint continuously.

### SUMMARY OF THE INVENTION

The present invention provides a reproduction apparatus, a generation apparatus, a control method, and a recording medium that ensure a suitable viewing experience when viewing free viewpoint image data.

The present invention in its first aspect provides a reproduction apparatus that reproduces free viewpoint image data which includes a plurality of images obtained by shooting a subject from different viewpoints, and from which a viewpoint image corresponding to a set viewpoint can be generated, the reproduction apparatus comprising: at least one processor and/or circuit; and at least one memory storing a computer program which causes the at least one processor and/or circuit to function as the following units: a determination unit configured to determine whether to perform brightness adjustment on the plurality of images according to the set viewpoint; and a correction unit configured to perform the brightness adjustment on the plurality of images when the viewpoint image is generated, wherein when the determination unit determines to perform the brightness adjustment, the correction unit performs a different brightness adjustment for (i) a first region corresponding to the subject in each of the plurality of images and (ii) a second region corresponding to parts aside from the subject.

The present invention in its second aspect provides a generation apparatus that generates free viewpoint image data which includes a plurality of images obtained by shooting a subject from different viewpoints, and from which a viewpoint image corresponding to a set viewpoint can be generated, the generation apparatus comprising: at least one processor and/or circuit; and at least one memory storing a computer program which causes the at least one processor and/or circuit to function as the following units: a determination unit configured to determine whether a viewpoint at which the plurality of images are to be subjected to brightness adjustment when generating the viewpoint image is present; a correction unit configured to perform the brightness adjustment on the plurality of images when the determination unit determines that a viewpoint at which the brightness adjustment is to be performed is present; and a generating unit configured to generate the free viewpoint image data further including the plurality of images subjected to the brightness adjustment by the correction unit, wherein the correction unit performs different brightness adjustment for (i) a first region corresponding to the subject in each of the plurality of images and (ii) a second region corresponding to parts aside from the subject.

The present invention in its third aspect provides a method for controlling a reproduction apparatus that reproduces free viewpoint image data which includes a plurality of images obtained by shooting a subject from different viewpoints, and from which a viewpoint image corresponding to a set viewpoint can be generated, the method comprising: determining whether to perform brightness adjustment on the plurality of images according to the set viewpoint; and performing the brightness adjustment on the plurality of images when the viewpoint image is generated, wherein when the brightness adjustment is determined to be performed, a different brightness adjustment is performed for (i) a first region corresponding to the subject in each of the plurality of images and (ii) a second region corresponding to parts aside from the subject.

The present invention in its fourth aspect provides a method for controlling a generation apparatus that generates free viewpoint image data which includes a plurality of images obtained by shooting a subject from different viewpoints, and from which a viewpoint image corresponding to a set viewpoint can be generated, the method comprising: determining whether a viewpoint at which the plurality of images are to be subjected to brightness adjustment when generating the viewpoint image is present; performing the brightness adjustment on the plurality of images when a viewpoint at which the brightness adjustment is to be performed is determined to be present; and generating the free viewpoint image data further including the plurality of images subjected to the brightness adjustment, wherein a different brightness adjustment is performed for (i) a first region corresponding to the subject in each of the plurality of images and (ii) a second region corresponding to parts aside from the subject.

The present invention in its fifth aspect provides a computer-readable recording medium on which is recorded a program for causing a computer to execute the method of controlling a reproduction apparatus of the third aspect.

The present invention in its sixth aspect provides a computer-readable recording medium on which is recorded a program for causing a computer to execute the method of controlling a generation apparatus of the fourth aspect.

Further features of the present invention will become apparent from the following description of exemplary embodiments (with reference to the attached drawings).

### BRIEF DESCRIPTION OF THE DRAWINGS

FIG. 1 is a diagram illustrating an example of the configuration of a reproduction system according to embodiments and variations of the present invention.

FIG. 2 is a block diagram illustrating an example of the functional configuration of an image capturing apparatus 300 according to embodiments and variations of the present invention.

FIGS. 3A and 3B are diagrams illustrating, in detail, the configuration of an image sensor provided in an image capturing unit 304 according to embodiments and variations of the present invention.

FIGS. 4A and 4B are diagrams illustrating the principles of range-finding performed using the image capturing unit 304 according to embodiments and variations of the present invention.

FIGS. 5A, 5B, and 5C are other diagrams illustrating the principles of range-finding performed using the image capturing unit 304 according to embodiments and variations of the present invention.

FIG. 6 is a block diagram illustrating an example of the functional configuration of a generation apparatus 200 according to embodiments and variations of the present invention.

FIG. 7 is a block diagram illustrating an example of the functional configuration of an image processing unit 105, pertaining to brightness adjustment, according to embodiments and variations of the present invention.

FIG. 8 is a flowchart illustrating an example of reproduction processing executed by the reproduction apparatus 100 according to embodiments and variations of the present invention.

FIG. 9 is a flowchart illustrating an example of brightness adjustment processing executed by the reproduction apparatus 100 according to embodiments and variations of the present invention.

FIGS. 10A, 10B, 10C, and 10D are diagrams illustrating an overview of brightness adjustment according to a first embodiment of the present invention.

FIGS. 11A, 11B, and 11C are diagrams illustrating an overview of brightness adjustment according to a first variation of the present invention.

FIG. 12 is a block diagram illustrating an example of the functional configuration of a generation apparatus 200 according to a third embodiment of the present invention.

### DESCRIPTION OF THE EMBODIMENTS

### First Embodiment

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The following embodiment will describe an example in which the present invention is applied in a reproduction apparatus 100 capable of receiving and reproducing free viewpoint image data as an example of a reproduction apparatus. However, the present invention can be applied in any device capable of adjusting the brightness of a plurality of images in accordance with a viewpoint set for reproduction of free viewpoint image data. In addition, in the present specification, “free viewpoint image data” refers to data including a plurality of images obtained by shooting a subject from different viewpoints, and is data with which a viewpoint image, in which a subject is captured from a viewpoint not restricted to the viewpoints from which the images were captured, can be generated from the plurality of images through reproduction.

### Reproduction System Configuration

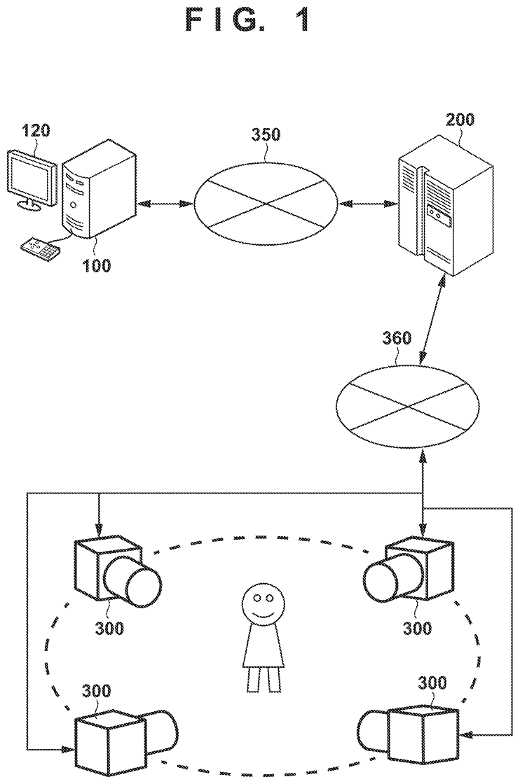

FIG. 1 is a system diagram illustrating an example of the configuration of a reproduction system according to the present embodiment. As illustrated in FIG. 1, the reproduction system is configured including a generation apparatus 200 that generates free viewpoint image data and a reproduction apparatus 100 that receives and reproduces the free viewpoint image data from the generation apparatus 200. The generation apparatus 200 is communicatively connected to a plurality of image capturing apparatuses 300 installed at different positions, which shoot a plurality of images to be included in the free viewpoint image data. The communication connection between the generation apparatus 200 and the reproduction apparatus 100, and between the generation apparatus 200 and each image capturing apparatus 300, is established over a network 350 and a network 360, which may be LANs, WANs, or the like, for example. In the example illustrated in FIG. 1, these communication connections are established over separate networks, but may be established over the same network. The communication connections can be wired or wireless.

Although not described in the present embodiment, the generation apparatus 200 controls the plurality of connected image capturing apparatuses 300 to shoot images in synchronization, obtains shot images pertaining to a plurality of viewpoints from the corresponding image capturing apparatuses 300, and generates the free viewpoint image data. The generation apparatus 200 also controls each of the image capturing apparatuses 300 to shoot images using the same shooting settings. Details will be given later, but in the present embodiment, each image capturing apparatus 300 is also configured to be capable of outputting distance information in the depth direction for objects, including a subject, present in a shooting range. This information can be used in the reproduction apparatus 100 when reproducing the free viewpoint image data. In the embodiment described hereinafter, the distance information is output having been stored in the free viewpoint image data in association with the shot images and information pertaining to the image capturing apparatuses 300 that generated those shot images (shooting settings, a shooting position and attitude, a shooting time, and the like).

### Functional Configuration of Image Capturing Apparatus

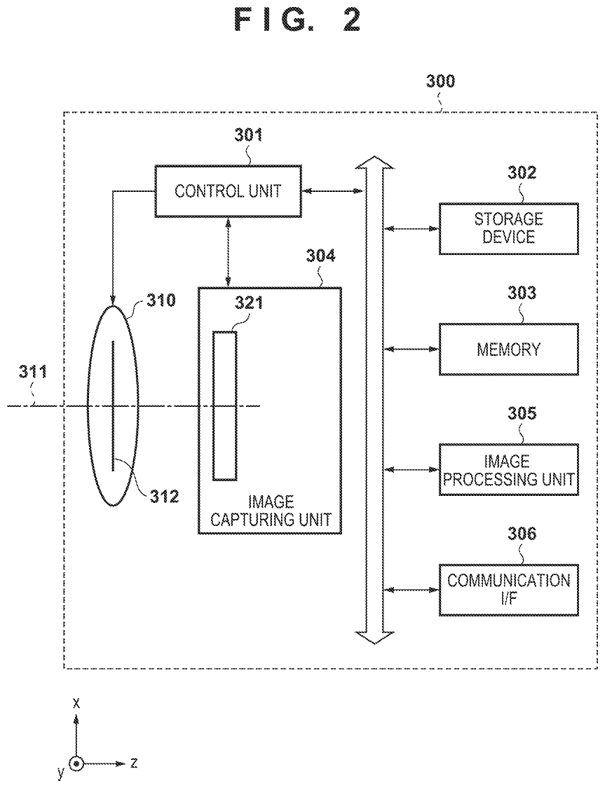

The functional configuration of the image capturing apparatus 300 according to the present embodiment will be described in detail here with reference to the block diagram in FIG. 2.

A control unit 301 is a control device, such as a CPU, a microprocessor, or the like, that controls the operations of the blocks in the image capturing apparatus 300. To be more specific, the control unit 301 reads out operation programs for each of the blocks, stored in a storage device 302, for example, loads the programs into a memory 303, and executes the programs to control the operations of those blocks.

The storage device 302 is a non-volatile memory, for example, and stores parameters and the like necessary for the blocks to operate in addition to the operation programs of the blocks. Meanwhile, the memory 303 is a recording device such as a volatile memory or the like used for a work region, temporary information storage, or the like. The memory 303 is used not only as a region for loading the operation programs, application programs, and the like, but also as a storage region for data outputted in the operations of the blocks, various types of data required for the operations of the blocks, and the like. The memory 303 is also assumed to store information of various settings of the image capturing apparatus 300 when capturing images (image capturing condition information), parameters pertaining to processing to be applied, and the like.

An image capturing unit 304 includes an image sensor 321 such as, for example, a CCD (charge-coupled device), a CMOS (complementary metal oxide semiconductor) sensor, or the like. The image capturing unit 304 photoelectrically converts an optical image formed on an image capturing plane of the image sensor 321 through an optical imaging system 310, and outputs an analog image signal. The output analog image signal is A/D-converted by an A/D conversion unit (not shown) and is output as a digital image signal.

Here, the optical imaging system 310 is an image capturing lens provided in the image capturing apparatus 300, and forms an optical image of a subject on the image capturing plane of the image sensor 321. The optical imaging system 310 may be constituted by a plurality of lenses (not shown) arranged on an optical axis 311, and includes an exit pupil 312 at a position a predetermined distance from the image sensor 321. Note that the present specification defines the direction parallel to the optical axis 311 as a z direction or a depth direction, the direction orthogonal to the optical axis 311 and parallel to the horizontal direction of the image sensor 321 as an x direction, and the direction parallel to the vertical direction of the image sensor 321 as the y direction, or provides such axes.

In the present embodiment, the image capturing unit 304 also functions as a means for obtaining distance information on the subject present in an image capturing range. Here, the distance information is information indicating the three-dimensional shape of the subject, but is assumed in the present embodiment to be two-dimensional information holding a distance from the image capturing apparatus 300 to the subject (a subject distance) for each pixel in the shot image (this may also be referred to as a “depth image” or “asperity information”). In order to obtain the distance information in an image processing unit 305 (described later), the image sensor 321 is configured to be capable of obtaining an image group used for rangefinding through the image plane-based phase-detection rangefinding method.

### Detailed Configuration of Image Sensor

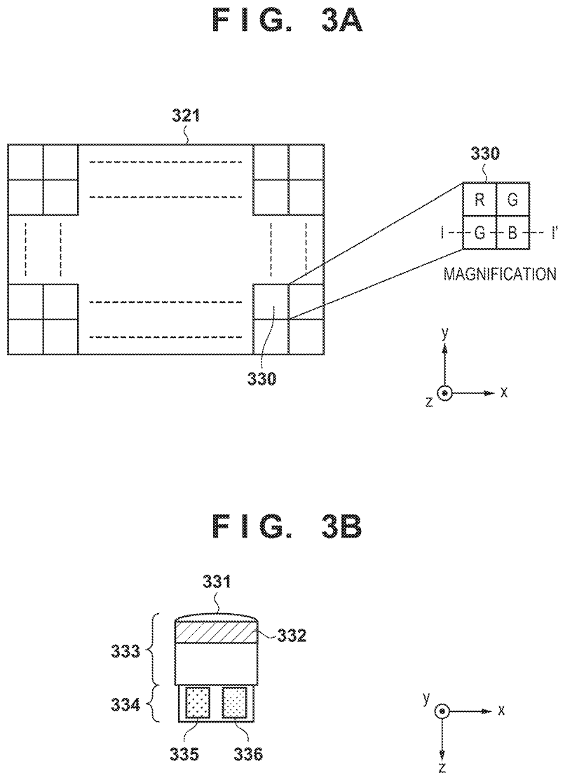

FIGS. 3A and 3B illustrate the configuration of the image sensor 321 in detail. As illustrated in FIG. 3A, the image sensor 321 is constituted by a plurality of pixel groups 330, each having two rows and two columns, to which different color filters have been applied, and which are connected in an array. As illustrated in the enlarged view, each pixel group 330 has red (R), green (G), and blue (B) color filters arranged, and an image signal indicating color information of either R, G, or B is output from each pixel (photoelectric conversion element). Although the present embodiment describes the color filters as being in a distributed form such as that illustrated, it is easy to understand that the present invention is not limited thereto.

To implement the image plane-based phase-detection rangefinding function of the image sensor 321 of the present embodiment, a single pixel (photoelectric conversion element) is constituted by a plurality of photoelectric conversion units arranged side by side in the I-I′ cross-section of FIG. 3A, which follows the horizontal direction of the image sensor 321. As illustrated in FIG. 3B, each pixel in the image sensor 321 is constituted by a light guide layer 333 including a microlens 331 and a color filter 332, and a light receiving layer 334 including a first photoelectric conversion unit 335 and a second photoelectric conversion unit 336.

In the light guide layer 333, the microlens 331 is configured to efficiently guide light beams incident on a pixel to the first photoelectric conversion unit 335 and the second photoelectric conversion unit 336. The color filter 332 transmits light in a predetermined wavelength band, and transmits only light in one of the aforementioned R, G, or B wavelength bands, guiding that light to the first photoelectric conversion unit 335 and the second photoelectric conversion unit 336 in the later stages.

The light receiving layer 334 is provided with two photoelectric conversion units (the first photoelectric conversion unit 335 and the second photoelectric conversion unit 336), which convert the received light into analog image signals, and two types of signals output from these two photoelectric conversion units are used for range-finding. In other words, each pixel of the image sensor 321 has two photoelectric conversion units arranged in the same horizontal direction, and an image signal constituted by the signals output from the first photoelectric conversion unit 335 of all the pixels, and an image signal constituted by the signals output from the second photoelectric conversion unit 336 of all the pixels, are used. In other words, the first photoelectric conversion unit 335 and the second photoelectric conversion unit 336 each partially receives the light beams incident on the pixels through the microlens 331. Accordingly, a pair of image signals ultimately obtained is a pupil-divided image group pertaining to light beams that have passed through different pupil regions of the exit pupil of the optical imaging system 310. In other words, the image sensor 321 of the present embodiment is configured to be capable of capturing an image from light beams that have passed through different pupil regions of the optical imaging system 310 separate from each other. Here, a combination of the image signals obtained from the photoelectric conversion by the first photoelectric conversion unit 335 and the second photoelectric conversion unit 336 in each pixel is equivalent to an image signal for viewing output from a single photoelectric conversion unit in a form in which only one photoelectric conversion unit is provided in the pixel.

Having such a structure makes it possible for the image sensor 321 of the present embodiment to output an image signal for viewing and an image signal for rangefinding (two types of pupil-divided images). Although the present embodiment describes all of the pixels in the image sensor 321 as having two photoelectric conversion units configured to be capable of outputting high-density depth information, the present invention is not limited thereto. For example, three or more photoelectric conversion units may be provided in each pixel, or pixels provided with a plurality of photoelectric conversion units may be limited to a part of the pixel group 330.

### Principles of Range-Finding

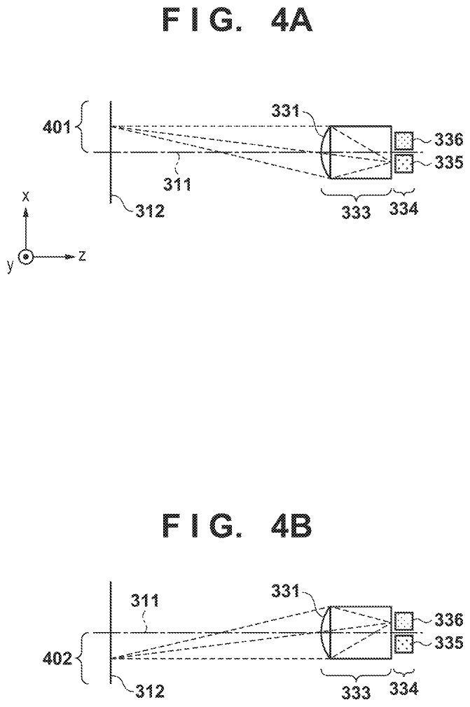

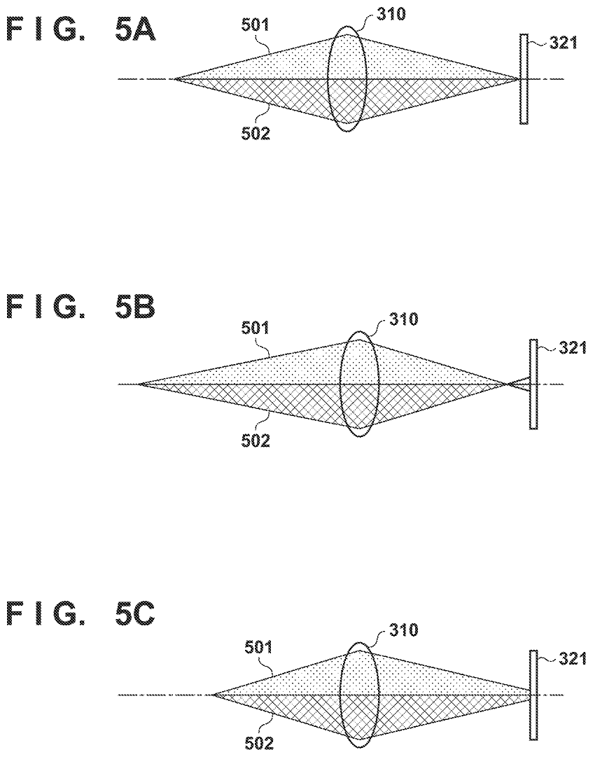

Next, the principles of measuring the subject distance based on the pupil-divided image group output from the first photoelectric conversion unit 335 and the second photoelectric conversion unit 336, which are used to configure the distance information in the image processing unit 305, will be described with reference to FIGS. 4A, 4B, 5A, 5B, and 5C. FIG. 4A is a schematic diagram illustrating the exit pupil 312 in the optical imaging system 310, and a light beam received by the first photoelectric conversion unit 335 of a pixel in the image sensor 321. FIG. 4B is a schematic diagram illustrating a light beam received by the second photoelectric conversion unit 336 in the same manner.

The microlens 331 illustrated in FIGS. 4A and 4B is disposed such that the exit pupil 312 and the light receiving layer 334 are in an optically conjugate relationship. The light beam passing through the exit pupil 312 of the optical imaging system 310 is focused by the microlens 331 and guided to the first photoelectric conversion unit 335 or the second photoelectric conversion unit 336. At this time, the light beams passing through the different pupil regions are mainly received by the first photoelectric conversion unit 335 and the second photoelectric conversion unit 336, respectively, as illustrated in FIGS. 4A and 4B. The light beam passing through a first pupil region 401 is received by the first photoelectric conversion unit 335, and the light beam passing through a second pupil region 402 is received by the second photoelectric conversion unit 336.

The plurality of first photoelectric conversion units 335 provided in the image sensor 321 mainly receive the light beam passing through the first pupil region 401, and output first image signals. At the same time, the plurality of second photoelectric conversion units 336 provided in the image sensor 321 mainly receive the light beam passing through the second pupil region 402, and output second image signals. An intensity distribution of the image formed on the image sensor 321 by the light beams passing through the first pupil region 401 can be obtained from the first image signals. Likewise, an intensity distribution of the image formed on the image sensor 321 by the light beams passing through the second pupil region 402 can be obtained from the second image signals.

The amount of relative positional shift between the first image signals and the second image signals (what is known as a “parallax amount”) is a value based on a defocus amount. The relationship between the parallax amount and the defocus amount will be described with reference to FIGS. 5A, 5B, and 5C. FIGS. 5A, 5B, and 5C are schematic diagrams illustrating a relationship between the image sensor 321 and the optical imaging system 310 of the present embodiment. Reference sign 501 in these drawings indicates a first light beam passing through the first pupil region 401, and reference sign 502 indicates a second light beam passing through the second pupil region 402.

FIG. 5A illustrates an in-focus state in which the first light beam 501 and the second light beam 502 converge on the image sensor 321. At this time, the parallax amount between the first image signal formed by the first light beam 501 and the second image signal formed by the second light beam 502 is 0. FIG. 5B illustrates a state of defocus in the negative direction of the z-axis on the image side. At this time, the parallax amount between the first image signal formed by the first light beam 501 and the second image signal formed by the second light beam 502 is not 0, but rather has a negative value. FIG. 5C illustrates a state of defocus in the positive direction of the z-axis on the image side. At this time, the parallax amount between the first image signal formed by the first light beam 501 and the second image signal formed by the second light beam 502 has a positive value. Comparing FIGS. 5B and 5C shows that the direction of the positional shift switches in accordance with whether the defocus amount is positive or negative. Furthermore, it can be seen that the positional shift occurs in accordance with the image formation relationship (geometric relationship) of the optical imaging system 310 according to the defocus amount. The parallax amount, which is the positional shift between the first image signal and the second image signal, can be detected by region-based matching processing.

The image processing unit 305 applies various types of image processing to the shot image obtained by the image capturing unit 304. The image processing unit 305 may be configured as one or more dedicated integrated circuits, or may be a function module implemented by software. The image processing unit 305 performs various types of signal processing such as noise removal, demosaicing, luminance signal conversion, aberration correction, white balance adjustment, color correction, and the like on the captured image signal output from the image sensor 321, and generates image data (a shot image). The image processing unit 305 also performs range-finding processing based on the principles of range-finding in the image plane-based phase-detection range-finding method described above, and configures the distance information corresponding to the shot image.

A communication I/F 306 is an interface, provided in the image capturing apparatus 300, for establishing a communication connection with an external device. The image capturing apparatus 300 of the present embodiment is connected to the generation apparatus 200, and thus the communication I/F 306 includes an interface for establishing a communication connection with the generation apparatus 200.

### Functional Configuration of Reproduction Apparatus

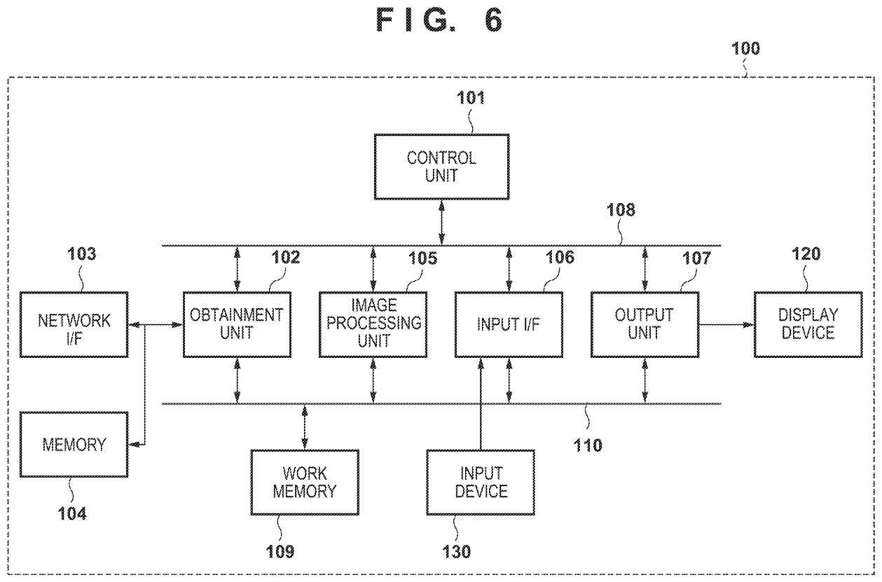

The functional configuration of the reproduction apparatus 100 according to the present embodiment will be described in detail next with reference to the block diagram in FIG. 6.

A control unit 101 is a control device, such as a CPU, a microprocessor, or the like, that controls the operations of the blocks in the reproduction apparatus 100. The control unit 101 includes a storage device such as a ROM, an HDD, or the like (not shown), and a RAM. The control unit 101 reads out operation programs for each of the blocks, stored in a storage device, for example, loads the programs into the RAM, and executes the programs to control the operations of those blocks.

An obtainment unit 102 obtains free viewpoint image data to be reproduced and loads the free viewpoint image data into the work memory 109, which is a data storage region for operations and is used for reproduction processing. In the reproduction system according to the present embodiment, the free viewpoint image data is received from the generation apparatus 200, and thus the obtainment unit 102 obtains the received free viewpoint image data. Data from the generation apparatus 200 is received through a network I/F 103. The network I/F 103 is an interface, provided in the reproduction apparatus 100, for establishing a communication connection with an external device. The network I/F 103 establishes a communication connection with the generation apparatus 200 over the network 350, and receives the free viewpoint image data. When the network I/F 103 receives the free viewpoint image data, that data is stored in a memory 104. Here, the memory 104 is a storage device such as a volatile memory or the like used for temporary information storage. The obtainment unit 102 therefore obtains the free viewpoint image data stored in the memory 104.

The image processing unit 105 performs various types of image processing pertaining to the reproduction of the free viewpoint image data. To be more specific, based on information on the position and attitude of a viewpoint set for reproduction (referred to as a “reproduction viewpoint” hereinafter), the image processing unit 105 performs processing for generating a viewpoint image pertaining to the reproduction viewpoint on the free viewpoint image data loaded into the work memory 109. As described above, a plurality of images in which a subject has been shot from different viewpoints are included in the free viewpoint image data, and thus the image processing unit 105 generates the viewpoint image by performing various types of image processing on the images involved in generating the viewpoint image pertaining to the reproduction viewpoint.

An input I/F 106 detects an operation input made through an input device 130, and outputs a corresponding control signal to the control unit 101. In the present embodiment, the input I/F 106 is mainly used for accepting operation inputs pertaining to setting (changing) the reproduction viewpoint. The input device 130 is a user interface provided in the reproduction apparatus 100, and can include, for example, buttons, a controller, a joystick, or the like provided in a housing of the reproduction apparatus 100, a touch panel for detecting touch operations made on a display device 120, and the like. The reproduction viewpoint may be changed by continuously changing the values of the position, attitude (line of sight direction), and the like of the viewpoint through a continuous analog input, or by selecting a discretely provided viewpoint.

An output unit 107 displays and outputs the viewpoint image from the reproduction viewpoint, generated by the image processing unit 105, to the display device 120. The display device 120 may be a display device such as an LCD or the like, for example, and is used to view the free viewpoint image data. The display device 120 may be configured as an integral part of the reproduction apparatus 100, or may be provided on the outside of the reproduction apparatus 100 in a removable state.

A control bus 108 and a data bus 110 are buses used for communication among the blocks. The control bus 108 is mainly used for sending and receiving control signals to and from the control unit 101 to control the operations of each block. The data bus 110 is mainly used to access the work memory 109 used in the reproduction processing of the free viewpoint image data.

### Reproduction of Free Viewpoint Image Data

An overview of the reproduction of the free viewpoint image data performed by the reproduction apparatus 100 having such a configuration will be given next.

In recent years, in general, a plurality of shot images that constitute free viewpoint image data are shot at a special studio or the like so that the subject appears in the viewpoint image in a suitable lighting state regardless of which viewpoint is selected. With such free viewpoint image data, a viewpoint image in which the subject appears in a suitable lighting state can be viewed in a stable manner while continuously changing the reproduction viewpoint.

The free viewpoint image data can also be configured using an image of a subject shot from a plurality of viewpoints without using a special studio. However, depending on the shooting environment of the subject, the locations of light sources may be unbalanced, and the subject may not appear in a suitable lighting state in viewpoint images pertaining to some reproduction viewpoints. It is therefore necessary to adjust the brightness of the shot images included in the free viewpoint image data to bring the subject into a suitable lighting state. However, the problem described above can arise due to the characteristics of free viewpoint image data, that is, that a viewpoint image generated having undergone brightness adjustment according to the reproduction viewpoint in this manner can be viewed while continuously changing the reproduction viewpoint. In other words, when reproducing free viewpoint image data while continuously changing the viewpoint, the background region may flicker in the viewpoint images presented in sequence, which can make it difficult to provide a suitable viewing experience.

Accordingly, in the reproduction apparatus 100 according to the present embodiment, when generating a viewpoint image pertaining to a reproduction viewpoint, the lighting state of the subject is determined, and the brightness adjustment performed on the plurality of shot images is changed based on the determination result. To be more specific, the image processing unit 105 separates each shot image into a subject region corresponding to the subject and a region corresponding to regions aside from the subject, and changes the brightness adjustment applied to the respective regions according to the reproduction viewpoint. The following descriptions will refer to the region corresponding to regions other than the subject as a “background region” for the sake of simplicity. However, the region other than the subject is not limited to the background, and a foreground and subjects other than a main subject may be included as well. To facilitate understanding of the invention, the present embodiment will describe the “subject” as a main subject used when shooting the free viewpoint image data. However, the present invention is not limited thereto, and the object to be used as the subject may be specified as appropriate, e.g., in accordance with a line of sight direction of the reproduction viewpoint, an operation input made by a user, or by analyzing the shot images.

Note that in the reproduction system according to the present embodiment, when the brightness of the subject region is low or high, that brightness is adjusted to generate a viewpoint image in which the subject is in a suitable lighting state. As such, the shot images output by the image capturing apparatuses 300 are assumed to be High Dynamic Range (HDR) images. In other words, each shot image is assumed to be an image signal in which the optical image of the subject has been converted to pixel values in a fixed brightness dynamic range based on an absolute brightness value such that the expression of details is not lost regardless of the lighting state. In addition, because the free viewpoint image data is obtained by compositing a plurality of shot images to generate a viewpoint image pertaining to a reproduction viewpoint, it is preferable that the same object located in the shooting environment (under the same lighting environment; the background or the like, for example) be displayed with the same color in each shot image. Accordingly, it is assumed that the plurality of shot images output by the plurality of image capturing apparatuses 300 are all shot using the same exposure settings, and are generated by converting the shot images into pixel values having the same brightness dynamic range.

### Functional Configuration Related to Brightness Adjustment of Free Viewpoint Image Data

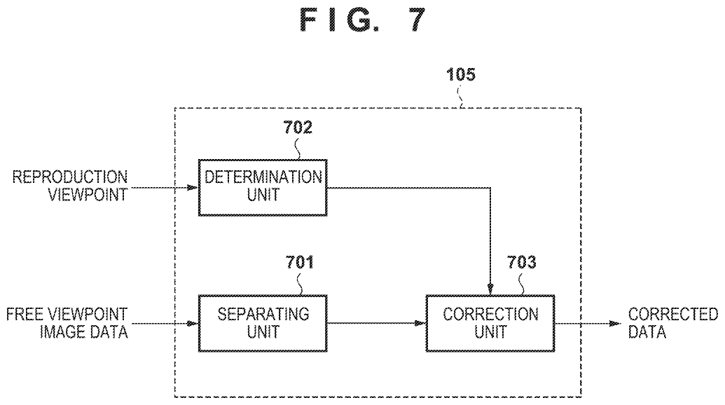

The functional configuration of the image processing unit 105 that executes the brightness adjustment processing on the free viewpoint image data, according to the present embodiment, will be described in detail next with reference to the block diagram in FIG. 7. As illustrated in FIG. 7, information on the reproduction viewpoint currently set and the free viewpoint image data loaded into the work memory 109 by the obtainment unit 102 are input to the image processing unit 105.

A separating unit 701 separates each of the plurality of shot images included in the input free viewpoint image data into a subject region and a background region. The separation by the separating unit 701 may be performed by extracting the pixels corresponding to each region from the shot images, or simply by classifying each pixel into one of the regions. The separating unit 701 of the present embodiment separates each shot image in the free viewpoint image data into a subject region and a background region based on distance information associated with the shot image.

Specifically, the separating unit 701 specifies a pixel position at which an image of a subject is displayed in a shot image pertaining to a single viewpoint, and determines a reference subject distance (a reference distance) for the subject from information on that pixel position in the corresponding distance information, for example. The separating unit 701 then extracts pixels for which a difference from the reference distance in the distance information is within a predetermined value, and separates a region formed by a group of those pixels which are contiguous with the specified pixel position into a subject region pertaining to that single viewpoint. The separating unit 701 can also separate other regions of the shot image, which have not been separated as the subject region, into the background region. Note that the subject can be a main subject in the free viewpoint image data, a subject designated by a user, or the like, for example.

A determination unit 702 determines whether to perform brightness adjustment specific to the input reproduction viewpoint. As will be described later, in the image processing unit 105 of the present embodiment, the plurality of shot images included in the free viewpoint image data are basically used to generate a viewpoint image having performed brightness adjustment according to a common standard for the subject region and the background region. However, if the lighting conditions in the shooting environment are unbalanced, a viewpoint where the brightness of the subject region is unsuitable even if the same brightness adjustment is performed can arise. For example, when a shot image output by an image capturing apparatus 300 located at a backlit position is subjected to the same brightness adjustment as shot images pertaining to other viewpoints, the brightness of the subject region may nevertheless remain low. In this manner, depending on the reproduction viewpoint which is set, it is necessary to perform brightness adjustment different from that applied to the background region in order to increase the brightness of the subject region.

Accordingly, in the present embodiment, the determination unit 702 determines whether to perform brightness adjustment specific to the reproduction viewpoint based on whether the brightness of the subject region at the reproduction viewpoint, estimated based on the plurality of shot images included in the input free viewpoint image data, is lower than a predetermined brightness. The brightness of the subject region at the reproduction viewpoint can be estimated based on, for example, the brightness of the subject region, among the subject regions at all viewpoints, which is at a viewpoint similar to the reproduction viewpoint. Here, the viewpoint similar to the reproduction viewpoint may be a viewpoint in which, for example, the degree of similarity with the reproduction viewpoint, derived for a combination of the position and attitude of the viewpoint, exceeds a threshold.

A correction unit 703 performs brightness adjustment on the plurality of shot images included in the free viewpoint image data. The brightness adjustment performed by the correction unit 703 is performed on both the subject region and the background region in each shot image.

To avoid a situation where the background region in the viewpoint image flickers when the reproduction viewpoint changes, the brightness adjustment on the background region is performed such that the brightness of an object at the same spatial position remains constant regardless of the reproduction viewpoint that is set. Accordingly, in the present embodiment, the correction unit 703 performs the brightness adjustment by specifying a brightness dynamic range throughout which the pixels in the background regions for all viewpoints are distributed, and converting that brightness dynamic range into a fixed brightness dynamic range. Once conversion characteristics for brightness adjustment are determined based on the brightness dynamic range of the background regions for all viewpoints, the correction unit 703 performs the brightness adjustment on the background region for each viewpoint using those conversion characteristics. In other words, the correction unit 703 adjusts the brightness of the background region for all viewpoints using the same conversion characteristics. Here, the conversion characteristics may be a predetermined conversion curve defining a relationship between input and output values, or may simply be a correction value that increases or reduces the brightness value uniformly.

On the other hand, the brightness adjustment for the subject region differs depending on the result of the determination by the determination unit 702. If the determination unit 702 determines that the brightness of the subject region at the reproduction viewpoint is lower than a predetermined brightness, the correction unit 703 performs the brightness adjustment on the subject region for each viewpoint based on the brightness of the subject region at the reproduction viewpoint. This brightness adjustment is performed, for example, by deriving a brightness dynamic range of the subject region at the reproduction viewpoint, and then using conversion characteristics for converting that brightness dynamic range into a fixed brightness dynamic range. Once conversion characteristics according to the reproduction viewpoint are derived, the correction unit 703 adjusts the brightness of the subject region for all viewpoints using those conversion characteristics. On the other hand, if the determination unit 702 determines that the brightness of the subject region at the reproduction viewpoint is not lower than the predetermined brightness, the correction unit 703 performs the brightness adjustment on the subject region for all viewpoints using the same conversion characteristics as those used for the brightness adjustment performed on the background region.

In this manner, the correction unit 703 performs different brightness adjustment on the background region and the subject region for all viewpoints at least when the determination unit 702 determines to perform brightness adjustment specific to the reproduction viewpoint. In other words, for the background region, the correction unit 703 performs the brightness adjustment such that the brightness of the same object remains constant regardless of the reproduction viewpoint, whereas for the subject region, the correction unit 703 changes the details of the brightness adjustment according to the reproduction viewpoint. To rephrase, in the brightness adjustment performed by the correction unit 703, the brightness adjustment width over which adjustment is possible is different for the background region and the subject region. To be more specific, for the background region, the brightness adjustment is performed using constant conversion characteristics, regardless of the reproduction viewpoint, whereas for the subject region, the brightness adjustment can be performed using different conversion characteristics according to the reproduction viewpoint. The brightness adjustment width for the subject region is therefore broader than the brightness adjustment width for the background region.

Once the brightness adjustment is complete for the background region and the subject region for all viewpoints, the correction unit 703 outputs free viewpoint image data including the adjusted background regions and subject regions (referred to simply as “corrected data” hereinafter to distinguish this data from the input free viewpoint image data). Generating a viewpoint image corresponding to the reproduction viewpoint using the corrected data output in this manner makes it possible to provide a suitable viewing experience for free viewpoint image data in which the brightness of the background region is stable.

Although the brightness adjustment of the free viewpoint image data described with reference to FIG. 7 has been described as being performed with all functional configurations operating each time a reproduction viewpoint is input, the present invention is not limited thereto. It goes without saying that as long as the same free viewpoint image data is used, the result of the separating unit 701 separating the subject region and the background region in the shot images at all viewpoints can be applied to different reproduction viewpoints. Additionally, when a reproduction viewpoint set in the past is set again for the same free viewpoint image data, a past determination result from the determination unit 702, a past brightness adjustment result by the correction unit 703 and conversion characteristics used in past adjustments, and the like can be applied as well.

### Reproduction Processing

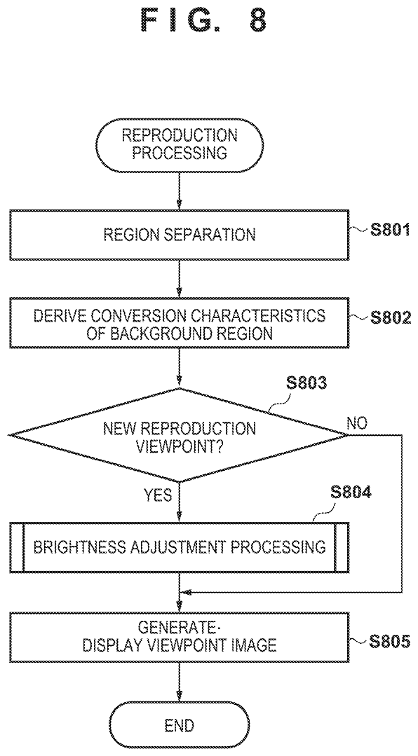

The reproduction processing performed by the reproduction apparatus 100 according to the present embodiment when reproducing the free viewpoint image data will be described in detail next with reference to the flowchart in FIG. 8. The processing corresponding to the flowchart can be performed by the image processing unit 105 by, for example, the control unit 101 reading out a corresponding processing program stored in the storage device, loading the program into the RAM, and executing the program. This reproduction processing will be described as being started when an operation input for reproducing free viewpoint image data is detected, for example. To facilitate understanding of the invention, the present embodiment assumes that the reproduced free viewpoint image data does not change.

In step S801, the image processing unit 105 inputs the shot images of all viewpoints included in the input free viewpoint image data into the separating unit 701, and the subject regions and the background regions are separated.

In step S802, the separating unit 701 specifies a brightness dynamic range for all the background regions based on the background regions of all viewpoints separated in step S801, and derives conversion characteristics for the brightness adjustment of the background regions based on that brightness dynamic range.

In step S803, the image processing unit 105 determines whether a new reproduction viewpoint has been set. In addition to when the reproduction viewpoint has been changed, the image processing unit 105 also determines that a new reproduction viewpoint has been set when the reproduction of the free viewpoint image data is started. The sequence moves to step S804 if the image processing unit 105 determines that a new reproduction viewpoint has been set, and to step S805 if not.

In step S804, the image processing unit 105 executes the brightness adjustment processing pertaining to the generation of the corrected data.

### Brightness Adjustment Processing

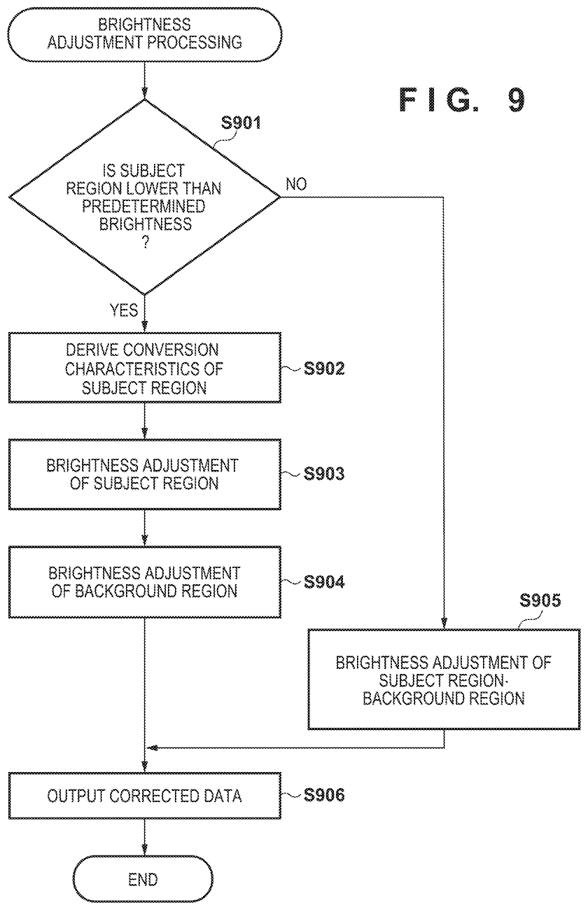

The brightness adjustment processing performed in this step will be described in detail here with reference to the flowchart in FIG. 9.

In step S901, the determination unit 702 determines whether the brightness of the subject region at the reproduction viewpoint is lower than a predetermined brightness. As described above, the determination in this step is made based on the brightness estimated based on the subject region of at a viewpoint, among all the viewpoints, which is similar to the reproduction viewpoint. The sequence moves to step S902 if the determination unit 702 determines that the brightness of the subject region at the reproduction viewpoint is lower than the predetermined brightness, and to step S905 if not.

In step S902, the correction unit 703 derives conversion characteristics for the brightness adjustment of the subject region based on the brightness of the subject region at the reproduction viewpoint estimated in step S901.

In step S903, the correction unit 703 performs the brightness adjustment on the subject region for all viewpoints based on the conversion characteristics derived in step S902.

In step S904, the correction unit 703 performs the brightness adjustment on the background region for all viewpoints based on the conversion characteristics derived in step S802 of the reproduction processing.

On the other hand, if it is determined in step S901 that the brightness of the subject region at the reproduction viewpoint is not lower than the predetermined brightness, in step S905, the correction unit 703 performs the brightness adjustment on the background region and the subject region for all viewpoints based on the conversion characteristics derived in step S802 of the reproduction processing.

In step S906, the correction unit 703 generates and outputs the corrected data (free viewpoint image data) using the background region and the subject region for all viewpoints after the brightness adjustment.

When the corrected data is generated by executing the brightness adjustment processing, the image processing unit 105 generates a viewpoint image corresponding to the reproduction viewpoint using the corrected data in step S805 of the reproduction processing. The output unit 107 also displays the generated viewpoint image in the display device 120.

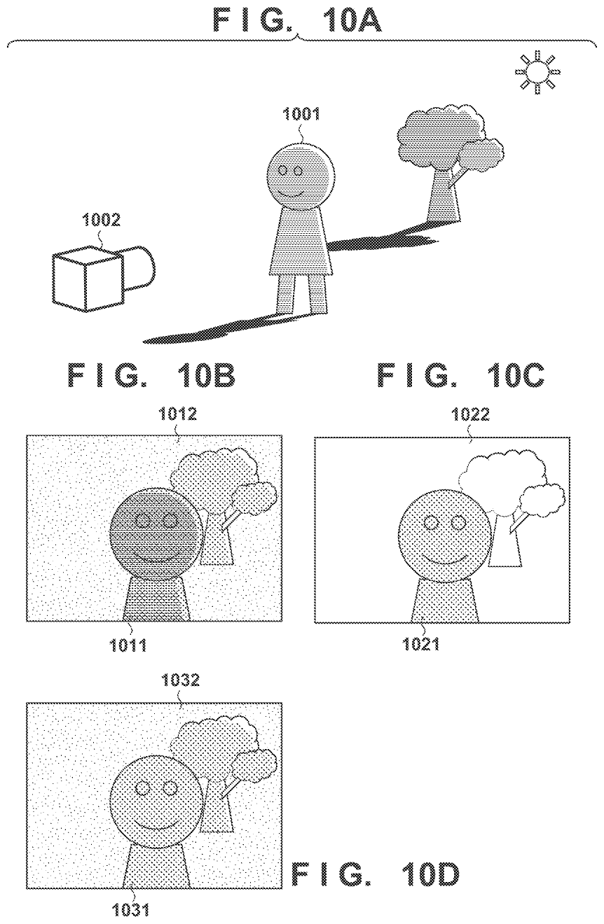

In this manner, according to the reproduction apparatus of the present embodiment, it is possible to ensure a suitable viewing experience for free viewpoint image data according to the reproduction viewpoint that is set. For example, consider a situation where, when viewing free viewpoint image data in which a subject 1001 has been shot in a shooting environment such as that illustrated in FIG. 10A, a viewpoint 1002 where the brightness of the subject region is lower than a predetermined brightness is set as the reproduction viewpoint. At this time, if the viewpoint image generated by correcting the shot image at all viewpoints such that the background region has a suitable brightness is like the image illustrated in FIG. 10B, a background region 1012 will have a suitable brightness, but a subject region 1011 will not. On the other hand, if the brightness is adjusted such that the subject region has a suitable brightness at the viewpoint 1002, a subject region 1021 in the viewpoint image will have a suitable brightness, but the brightness of a background region 1022 will increase, as illustrated in FIG. 10C. In other words, a viewpoint image is generated in which a user can notice flickering in the background region when viewing the free viewpoint image data. In the reproduction apparatus according to the present embodiment, the mode of the brightness adjustment is different for the subject region and the background region according to the reproduction viewpoint. As such, when the viewpoint 1002 is set, brightness adjustment specific to the viewpoint is applied to the subject region, and a viewpoint image such as that illustrated in FIG. 10D is therefore generated. As illustrated in the figures, in the viewpoint image, a subject region 1031 has a similarly suitable brightness as the subject region 1021 in FIG. 10C, and a background region 1032 has a similarly suitable brightness as the background region 1012 in FIG. 10B.

The present embodiment has described the processing as being implemented by hardware such as circuits, processors, and the like corresponding to the blocks included in the reproduction apparatus 100. However, the present invention is not limited thereto, and the processing by the blocks may be implemented by programs that perform the same processing as those blocks.

Additionally, the present embodiment describes the correction unit 703 as performing the brightness adjustment for the subject region at all viewpoints using the same conversion characteristics as for the background region when it is determined that brightness adjustment specific to the viewpoint is not to be performed for the reproduction viewpoint. However, the present invention is not limited thereto. In other words, the present invention does not preclude performing different brightness adjustment for the subject region and the background region when it is determined that brightness adjustment specific to the viewpoint is not to be performed for the reproduction viewpoint.

Additionally, the present embodiment describes the correction unit 703 as performing the brightness adjustment on the subject region for all the viewpoints using the conversion characteristics according to the brightness of the subject region at the reproduction viewpoint, when it is determined that brightness adjustment specific to the viewpoint is to be performed for the reproduction viewpoint. However, the present invention is not limited thereto, and the brightness adjustment using the conversion characteristics according to the brightness of the subject region at the reproduction viewpoint may be performed only on the subject region at some of the viewpoints referred to when generating the viewpoint image corresponding to that reproduction viewpoint.

### First Variation

The descriptions in the foregoing embodiment assumed that there is no object further in the foreground than the subject used for the subject region (i.e., closer to a reproduction viewpoint than the subject when viewed from that reproduction viewpoint), as illustrated in FIGS. 10A, 10B, 10C, and 10D. However, depending on the arrangement of the foreground object and the subject as seen from the reproduction viewpoint, the viewpoint image may not have a suitable form when the foreground object is classified as a background region and subjected to brightness adjustment.

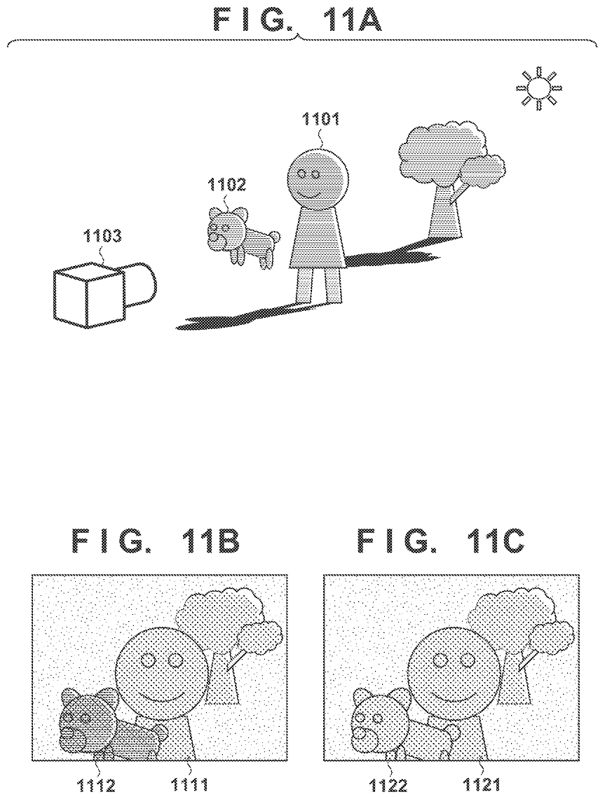

For example, when a person 1101 who is the subject and a dog 1102 which is an object different from the subject are arranged in a shooting environment, the arrangement of the images thereof in the viewpoint image changes according to the reproduction viewpoint that is set, as illustrated in FIG. 11A. When a viewpoint 1103 indicated in the figure is selected as the reproduction viewpoint, if the brightness of the subject region pertaining to the person 1101 is lower than a predetermined brightness, the correction unit 703 will generate the corrected data by performing different brightness adjustments on the subject region and the background region for all viewpoints. At this time, the viewpoint image corresponding to the viewpoint 1103 generated using the corrected data will be as illustrated in FIG. 11B, but a brightness adjustment such as that performed for the subject region will not be performed for a region 1112 in which the image of the dog 1102, which is classified as the background region, is displayed. Accordingly, in the example illustrated in FIG. 11B, despite the region 1112 of the dog 1102 and a region 1111 of the person 1101 overlapping in the viewpoint image as seen from the viewpoint 1103, the brightnesses of the regions are different, resulting in an unnatural appearance.

Accordingly, if, when separating the subject region based on depth information, there is an object distributed closer than the subject in the reproduction viewpoint and the region thereof overlaps with the subject region when viewed from the reproduction viewpoint, the separating unit 701 separates the region of that object into the subject region. In other words, after determining whether such an object is present for the reproduction viewpoint, the separating unit 701 controls the region separation for the shot images at each viewpoint based on a result of the determination. Doing so makes it possible to present a suitable viewpoint image, such as that illustrated in FIG. 11C, for example. In other words, the regions in which the person 1101 and the dog 1102 appear are separated into the subject region by the separating unit 701, and thus a region 1121 of the person 1101 and a region 1122 of the dog 1102 are subjected to the brightness adjustment in a suitable form based on common conversion characteristics.

### Second Variation

The foregoing embodiment described a form in which whether to perform brightness adjustment specific to the reproduction viewpoint is determined by estimating the brightness of the subject region at the reproduction viewpoint based on the brightness of the subject region at a viewpoint, among all the viewpoints included in the free viewpoint image data, that is similar to the reproduction viewpoint. However, the present invention is not limited thereto. For example, the position of a light source disposed in the shooting environment may be specified from the shot images at all the viewpoints included in the free viewpoint image data, and when the reproduction viewpoint is in a backlit relationship with the light source, brightness adjustment specific to the reproduction viewpoint may be determined to be performed. In other words, the determination unit 702 determines whether the reproduction viewpoint is in a backlit position based on (i) the position and attitude of the reproduction viewpoint and (ii) the position of the light source when shooting each image included in the free viewpoint image data. Then, when the reproduction viewpoint is in a backlit position, the correction unit 703 may perform brightness adjustment using different conversion characteristics for the subject region and the background region for all the viewpoints.

### Second Embodiment

The foregoing embodiment and variations have described determining whether to perform brightness adjustment specific to the reproduction viewpoint based only on the position and attitude of the reproduction viewpoint. However, the present invention is not limited thereto. For example, it is conceivable that even if the reproduction viewpoint is in the backlit position, if the image of the subject is displayed at a small size in the viewpoint image, the effect of improving the viewing experience for the user will be small even if brightness adjustment is performed. Accordingly, brightness adjustment different from that performed on the background region may be performed on the subject region when the subject region is displayed larger than a predetermined surface area in the viewpoint image.

Whether the subject region is displayed larger than the predetermined surface area can be determined based on, for example, a viewing distance, which is a distance between the set reproduction viewpoint and the subject. Accordingly, when the determination unit 702 determines that the viewing distance is shorter than a predetermined distance (closer) and that the brightness of the subject region at the reproduction viewpoint is lower than a predetermined brightness, the corrected data may be generated by performing different brightness adjustment on the background region and the subject region.

### Third Variation

Although the foregoing embodiment and variation described the reproduction viewpoint as being changed based on an operation input made using the input device 130, the present invention is not limited thereto. For example, when a head-mounted display (HMD) is used as the display device 120, the reproduction viewpoint may be changed in accordance with the position and attitude of the HMD as opposed to through a manual operation input.

In addition, the setting of the reproduction viewpoint may be made without the input of the user using the generation apparatus 200. For example, information on a change to the viewpoint can be received from the generation apparatus 200, an external device, or the like over the network 350, and the reproduction viewpoint can be set based on that information. When information on the change to the viewpoint is associated with the free viewpoint image data in advance, the reproduction viewpoint can also be set by reading out the information.

### Fourth Variation

The foregoing embodiments and variations have described using the image capturing apparatuses 300, which can record pupil-divided images, and obtaining the depth information used to separate the shot image at each viewpoint into a subject region and a background region based on those pupil-divided images. However, the present invention is not limited thereto, and similar information can be obtained and used by providing the image capturing apparatus 300 with a Time of Flight (ToF) sensor, or by separately providing a Light Detection and Ranging (LiDAR) device, for example.

In addition, rather than obtaining the depth information, a trained model which has been trained on subject regions for shot images may be used, and the region separation may be performed based on a result of specifying the subject region inferred by the trained model.

### Third Embodiment

The foregoing embodiments and variations have described the reproduction apparatus 100 as generating corrected data by performing brightness adjustment according to the set reproduction viewpoint. However, the present invention is not limited thereto. Whether it is necessary to perform different brightness adjustment on the background region and the subject region according to the viewpoint can be determined before viewing. Accordingly, the brightness adjustment may be performed in the generation apparatus 200, included in the free viewpoint image data, and provided to the reproduction apparatus 100, for example.

### Functional Configuration of Generation Apparatus

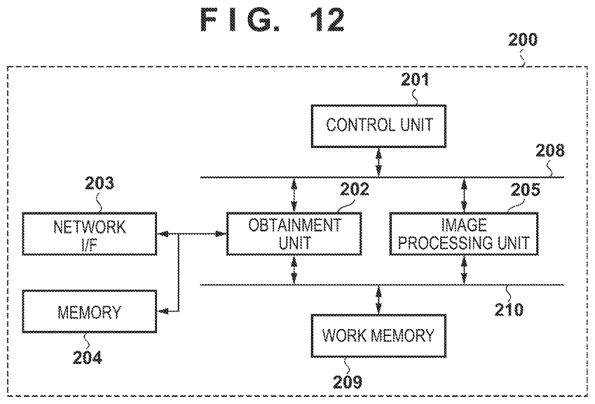

First, the functional configuration of the generation apparatus 200 according to the present embodiment will be described with reference to the block diagram in FIG. 12.

A control unit 201 is a control device, such as a CPU, a microprocessor, or the like, that controls the operations of the blocks in the generation apparatus 200. The control unit 201 includes a storage device such as a ROM, an HDD, or the like (not shown), and a RAM. The control unit 201 reads out operation programs for each of the blocks, stored in a storage device, for example, loads the programs into the RAM, and executes the programs to control the operations of those blocks.

An obtainment unit 202 obtains shot images and distance information for all viewpoints included in the free viewpoint image data, and loads the shot images and distance information into a work memory 209, which is a data storage region for work used in the processing for generating the free viewpoint image data. The generation apparatus 200 of the present embodiment receives the shot images and distance information from the plurality of connected image capturing apparatuses 300, and as such, the obtainment unit 202 obtains the received shot images and distance information. Data from the image capturing apparatus 300 is received through a network I/F 203. The network I/F 203 is an interface, provided in the generation apparatus 200, for establishing a communication connection with an external device. The network I/F 203 establishes communication connections with the plurality of image capturing apparatuses 300 over the network 360, and receives shot images and distance information for each viewpoint. When the network I/F 203 receives the shot images, that data is stored in a memory 204. Here, the memory 204 is a storage device such as a volatile memory or the like used for temporary information storage. Accordingly, the obtainment unit 202 obtains the shot images and distance information stored in the memory 204.

An image processing unit 205 performs various types of image processing pertaining to the generation of the free viewpoint image data. To be more specific, the image processing unit 205 generates the free viewpoint image data in association with the shot image, the distance information, and information on the position and attitude of the viewpoint (the image capturing apparatus 300) at which the shot image was shot, obtained from each of the image capturing apparatuses 300. In the present embodiment, the image processing unit 205 generates the free viewpoint image data including the images of the subject region and the background region after the brightness adjustment, as will be described later. The generated free viewpoint image data is sent to the reproduction apparatus 100 through the network I/F 203.

A control bus 208 and a data bus 210 are buses used for communication among the blocks. The control bus 208 is mainly used for sending and receiving control signals to and from the control unit 201 to control the operations of each block. The data bus 210 is mainly used to access the work memory 109 used in the processing for generating the free viewpoint image data.

### Generation of Free Viewpoint Image Data

An overview of the processing for generating the free viewpoint image data, performed by the generation apparatus 200 according to the present embodiment, will be described next. Note that the brightness adjustment processing in the generation processing executed by the generation apparatus 200 is basically performed in the same manner as described above with respect to the reproduction apparatus 100, and thus the functional configuration pertaining to the brightness adjustment performed by the image processing unit 205 will not be described.

The brightness adjustment processing performed by the generation apparatus 200 differs from the brightness adjustment processing performed by the reproduction apparatus 100 described above in the following respects. In the reproduction apparatus 100, the reproduction viewpoint pertaining to the reproduction of the free viewpoint image data having been set is used as a condition to determine whether to perform different brightness adjustment on the subject region and the background region according to the reproduction viewpoint (whether to perform brightness adjustment specific to the reproduction viewpoint). On the other hand, the generation apparatus 200 specifies a viewpoint where brightness adjustment specific to the reproduction viewpoint is necessary, generates information on the image that has undergone brightness adjustment adapted to that viewpoint in advance, and includes that information in the free viewpoint image data. In other words, rather than performing the necessary brightness adjustment in accordance with the setting of the reproduction viewpoint, the generation apparatus 200 specifies the viewpoint at which individual brightness adjustment should be performed for the subject region based on the shot images at all the obtained viewpoints, and generates the image of the subject region to which the brightness adjustment is applied according to that viewpoint.

Accordingly, the free viewpoint image data generated by the generation apparatus 200 according to the present embodiment includes the following two types of information on the images pertaining to the plurality of viewpoints. One is an image of the background region and the subject region for all viewpoints subjected to brightness adjustment using common conversion characteristics based on the brightness dynamic range of the background region for all viewpoints. The other is an image of the subject region at all viewpoints subjected to brightness adjustment using conversion characteristics according to the brightness of the subject region at a viewpoint where the brightness of the subject region is lower than a predetermined brightness. In other words, the free viewpoint image data output by the generation apparatus 200 according to the present embodiment can be used to generate a viewpoint image in a suitable state in advance, regardless of which reproduction viewpoint has been selected in the reproduction apparatus 100. In other words, the free viewpoint image data output by the generation apparatus 200 according to the present embodiment can be used to generate a viewpoint image in a suitable state corresponding to a desired reproduction viewpoint, without performing brightness adjustment processing in the reproduction apparatus 100. This makes it possible to reduce the computational load in the reproduction apparatus 100.

### Fifth Variation

The foregoing embodiments assume that the reproduced free viewpoint image data does not change, i.e., that the state of the shooting environment at the timing at which the shooting was performed is information that can be viewed while changing the viewpoint. In other words, the free viewpoint image data corresponds to a still image that can be viewed while changing the viewpoint. However, the present invention is not limited thereto, and the free viewpoint image data may correspond to a moving image that can be viewed while changing the viewpoint. In other words, it goes without saying that the present invention can be applied in an embodiment in which the free viewpoint image data is provided as data that constitutes each frame in a moving image. In other words, the present invention can be used to provide a suitable viewing experience in a form in which, for example, free viewpoint image data is sequentially provided to the reproduction apparatus 100 from the generation apparatus 200 as a television broadcast, video distribution, or the like.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A reproduction apparatus that reproduces free viewpoint image data that includes a plurality of images obtained by shooting a subject from different viewpoints, and from which a viewpoint image corresponding to a set viewpoint can be generated, the reproduction apparatus comprising:
at least one processor and/or circuit; and
at least one memory storing a computer program which causes the at least one processor and/or circuit to function as the following units:
a determination unit configured to determine whether to perform brightness adjustment on the plurality of images according to the set viewpoint; and
a correction unit configured to perform the brightness adjustment on the plurality of images when the viewpoint image is generated,
wherein, when the determination unit determines to perform the brightness adjustment, the correction unit performs a different brightness adjustment for (i) a first region corresponding to the subject in each of the plurality of images and (ii) a second region corresponding to parts aside from the subject.

2. The reproduction apparatus according to claim 1, wherein the plurality of images are digital image signals shot using common exposure settings and converted into pixel values in a common brightness dynamic range.

3. The reproduction apparatus according to claim 2, wherein, in the brightness adjustment performed by the correction unit, a brightness adjustment width over which adjustment can be performed is set to be different for the first region and the second region, and
the brightness adjustment width for the first region is set to be broader than the brightness adjustment width for the second region.

4. The reproduction apparatus according to claim 1, wherein the brightness adjustment for the second region is adjustment that sets a brightness of an object at the same spatial position to be constant regardless of the set viewpoint.

5. The reproduction apparatus according to claim 1, wherein, when a brightness of the first region at the set viewpoint is lower than a predetermined brightness, the determination unit determines to perform the brightness adjustment on the plurality of images.

6. The reproduction apparatus according to claim 1, wherein the determination unit determines whether to perform the brightness adjustment on the plurality of images based on (i) a position and an attitude of the set viewpoint and (ii) a position of a light source during shooting.

7. The reproduction apparatus according to claim 6, wherein the determination unit determines to perform the brightness adjustment on the plurality of images when the set viewpoint is in a backlit relationship with the light source during the shooting.

8. The reproduction apparatus according to claim 1, wherein when the determination unit determines to perform the brightness adjustment, the correction unit performs at least the brightness adjustment on the first region under a condition that a viewing distance of the subject corresponding to the set viewpoint is shorter than a predetermined distance.

9. The reproduction apparatus according to claim 1, wherein the program further causes the at least one processor and/or circuit to function as a specifying unit configured to specify the subject for each of the plurality of images, and
the correction unit determines the first region and the second region for each of the plurality of images based on a specifying result from the specifying unit.

10. The reproduction apparatus according to claim 9, wherein the specifying unit specifies the subject for each of the plurality of images based on distance information in a depth direction corresponding to respective ones of the plurality of images.

11. The reproduction apparatus according to claim 10, wherein each of the plurality of images is a pair of images shot by dividing a light beam passing through different pupil regions of an imaging optical system, and
the specifying unit generates the distance information based on the pair of images pertaining to each of the plurality of images.

12. The reproduction apparatus according to claim 9, wherein the correction unit causes a region of an object that, as seen from the set viewpoint, is present closer than the subject specified by the specifying unit, and that overlaps with the region of the subject, to be included in the first region.

13. The reproduction apparatus according to claim 1, wherein the second region is a background region.

14. The reproduction apparatus according to claim 1, wherein the program further causes the at least one processor and/or circuit to function as an input unit configured to accept a setting of the viewpoint.

15. The reproduction apparatus according to claim 1, wherein the program further causes the at least one processor and/or circuit to function as a generating unit configured to generate a viewpoint image corresponding to the set viewpoint.

16. The reproduction apparatus according to claim 1, wherein the free viewpoint image data is data constituting each of frames of a moving image.

17. A generation apparatus that generates free viewpoint image data that includes a plurality of images obtained by shooting a subject from different viewpoints, and from which a viewpoint image corresponding to a set viewpoint can be generated, the generation apparatus comprising:
at least one processor and/or circuit; and
at least one memory storing a computer program which causes the at least one processor and/or circuit to function as the following units:
a determination unit configured to determine whether a viewpoint at which the plurality of images are to be subjected to brightness adjustment when generating the viewpoint image is present;
a correction unit configured to perform the brightness adjustment on the plurality of images when the determination unit determines that a viewpoint at which the brightness adjustment is to be performed is present; and
a generating unit configured to generate the free viewpoint image data further including the plurality of images subjected to the brightness adjustment by the correction unit,
wherein the correction unit performs different brightness adjustment for (i) a first region corresponding to the subject in each of the plurality of images and (ii) a second region corresponding to parts aside from the subject.

18. A method of controlling a reproduction apparatus that reproduces free viewpoint image data which includes a plurality of images obtained by shooting a subject from different viewpoints, and from which a viewpoint image corresponding to a set viewpoint can be generated, the method comprising:
determining whether to perform brightness adjustment on the plurality of images according to the set viewpoint; and
performing the brightness adjustment on the plurality of images when the viewpoint image is generated,
wherein, when the brightness adjustment is determined to be performed, a different brightness adjustment is performed for (i) a first region corresponding to the subject in each of the plurality of images and (ii) a second region corresponding to parts aside from the subject.

19. A method for controlling a generation apparatus that generates free viewpoint image data which includes a plurality of images obtained by shooting a subject from different viewpoints, and from which a viewpoint image corresponding to a set viewpoint can be generated, the method comprising:
determining whether a viewpoint at which the plurality of images are to be subjected to brightness adjustment when generating the viewpoint image is present;
performing the brightness adjustment on the plurality of images when a viewpoint at which the brightness adjustment is to be performed is determined to be present; and
generating the free viewpoint image data further including the plurality of images subjected to the brightness adjustment,
wherein a different brightness adjustment is performed for (i) a first region corresponding to the subject in each of the plurality of images and (ii) a second region corresponding to parts aside from the subject.

20. A computer-readable recording medium on which is recorded a program for causing a computer to execute the method of controlling a reproduction apparatus according to claim 18.

21. A computer-readable recording medium on which is recorded a program for causing a computer to execute the method of controlling a generation apparatus according to claim 19.
